(19) United States
(12) Patent Application Publication
(10) Pub. No.: US 2025/0155311 A1
(43) Pub. Date: May 15, 2025

(54) METHOD FOR REDUCING AN UNBALANCE OF A ROTATIONAL COMPONENT FOR AN ELECTRIC PUMP, BALANCING MACHINE, COMPUTER PROGRAM, COMPUTER-READABLE MEDIUM, AND ROTATIONAL COMPONENT FOR THE METHOD

(71) Applicant: Schaeffler Technologies AG & Co. KG, Herzogenaurach (DE)

(72) Inventors: Lucas SANTIN, Hofheim (DE); Peter HEYDTMANN, Oberursel (DE); Markus GRAF, Pfatter (DE)

(21) Appl. No.: 18/947,133

(22) Filed: Nov. 14, 2024

(30) Foreign Application Priority Data
Nov. 15, 2023 (DE) 10 2023 211 339.2

(51) Int. Cl. G01M 1/34; B23K 26/36; F04D 29/66

(52) U.S. Cl. CPC G01M 1/34; B23K 26/36; F04D 29/66

(57) ABSTRACT

A method for reducing an unbalance of a rotational component for an electric pump and a balancing machine. The method includes individual material removals by laser radiation and associated material removal variables, which are selected such that the resulting unbalance of the rotational component after a material removal corresponds to a variable below a threshold value variable.

### BACKGROUND OF THE INVENTION

### 1. Field of the Invention

The disclosure relates to a method for reducing an unbalance of a rotational component for an electric pump, a balancing machine, a computer program, and a computer-readable medium.

### 2. Description of Related Art

Damage can occur on pumps due to an unbalance of a rotational component. Such an unbalance can also result in acoustic disturbances. It is therefore of great importance to reduce the unbalance.

Documents DE 10 2014 103 060 A1 and EP 0 922 208 A1 relate to a method and a device for balancing rotors.

The devices in the prior art in particular have the disadvantage of the long duration of a balancing process.

### SUMMARY OF THE INVENTION

It is an object of one aspect of the present invention to provide an alternative method for reducing an unbalance of a rotational component for an electric pump, which is distinguished in particular by its short duration. A further object is to provide a balancing machine which is configured to carry out this method. A further object is to provide a computer program for carrying out the method. A further object is to provide a computer-readable medium having the computer program. A further object is to provide a rotational component for the method according to the invention.

An exemplary aspect of the invention relates to a method for reducing an unbalance of a rotational component for an electric pump, comprising:
determining an unbalance of the rotational component,
reducing the unbalance by a material removal on the rotational component if the unbalance corresponds to at least one threshold value variable,
wherein the material removal comprises at least two individual material removals by laser radiation,
wherein the individual material removals are each assigned one of at least two standardized material removal variables,
wherein the at least two material removal variables differ from one another due to unbalance reducing variables assigned thereto,
determining the number of individual material removals and their material removal variables such that the resulting unbalance of the rotational component after the material removal corresponds to a variable less than the threshold value variable.

In this way, a method is provided which is distinguished from the method in the prior art by its extremely short duration. This is above all because the individual material removals are determined in their required number and their required material removal variable before the material removal begins.

Preferably, the individual material removals and/or the material removal form recesses in the form of circle segments or ring segments on the rotational component.

It is particularly advantageous if the laser radiation comprises at least one laser beam. The laser radiation or the laser beam is preferably generated by a laser source, such as a laser diode.

It is also advantageous if the unbalance of the rotational component is determined by a balancing machine. The balancing machine preferably has a separately provided sensor for this purpose. For example, the unbalance is determined by setting the rotational component into rotation and measuring a radial force occurring due to the unbalance by the sensor, from which the unbalance can be concluded.

The statement that the unbalance corresponds to at least one threshold value variable is preferably to be understood such that a or the variable of the unbalance at least corresponds to the threshold value variable.

Furthermore, it is preferred if the determination of the number of individual material removals and their material removal variables takes place before the reduction, which is associated therewith in particular, of the unbalance.

It is particularly advantageous if an algorithm and/or an artificial intelligence is used for the determination of the number of individual material removals and their material removal variables. This method step can be automated thereby.

Furthermore, it is advantageous if the number of individual material removals and their material removal variables are determined on the basis of preceding balancing profile data.

The method steps which do not require specific devices to be carried out are preferably computer-implemented method steps.

In general, it is preferred if a or the unbalance reducing variable or the unbalancing reducing variables is or are to be understood as a variable which represents a measure for the reduction of the unbalance. In other words, the unbalance is reduced more strongly the greater a or the unbalance reducing variable is or the unbalance reducing variables are.

In addition, it is expedient if the rotational component for the electric pump is a rotor or a pump impeller. In addition, it is expedient if the rotational component of the electric pump is a rotor-pump impeller unit. Independently of how the rotational component is designed, it is preferred in principle if the rotational component comprises plastic or at least partially consists of plastic. It is particularly preferred if the rotational component comprises plastic at the points at which the material removal is performed or that the rotational component consists of plastic at least at these points. The plastic is preferably a plastic that is matched to the laser radiation or the at least one laser beam, in particular in such a way that the laser radiation or the at least one laser beam generates or performs a material removal upon striking the plastic. Alternatively, it is conceivable that the rotational component consists of brass, for which a higher application of energy is necessary for the individual material removal and/or the laser and/or the laser beam, however, than in the case of a rotational component made of plastic.

The rotational component is preferably designed in such a way that it comprises a material accumulation and/or material accumulations, in particular made of plastic or brass, which are designed and/or provided to enable the reduction of the unbalance by the material removal on the rotational component. In other words, special points are provided on the rotational component, at which the material removal and/or the individual material removals can be performed to reduce the unbalance.

One preferred exemplary aspect is characterized in that the individual material removals take place at least partially simultaneously or in succession.

Additional time can be saved with simultaneous individual material removals. Multiple individual material removals are preferably each carried out by at least one laser beam in this case. The laser source preferably comprises for this purpose one laser diode per individual material removal, which are carried out simultaneously.

In the case that the laser source is only capable of generating a single laser beam, it is advantageous if no further determination of the unbalance of the rotational component takes place between the successively occurring individual material removals. Time is saved in this way. The goal is to reduce the time required to achieve falling below the threshold value variable, which is avoided by omitting intermediate measurements to determine the remaining unbalance after each completed individual material removal.

A further preferred exemplary embodiment is characterized in that after the reduction of the unbalance, the resulting unbalance of the rotational component is ascertained, wherein the method is repeated if, after the reduction of the unbalance, the resulting unbalance of the rotational component at least corresponds to the threshold value variable, and/or the method is ended if, after the reduction of the unbalance, the resulting unbalance of the rotational component is below the threshold value variable.

It is ensured by the repetition of the method that the unbalance is reduced such that it is below the threshold value variable.

Time is saved by ending the method when it is established that the unbalance has already been reduced to a variable which meets the demands of the rotational component in its area of use.

A further preferred exemplary embodiment is characterized in that the method furthermore comprises the following:
correcting the standardized material removal variables when the resulting unbalance of the rotational component after the material removal deviates from a variable which differs from the unbalance minus the unbalance reduction variables of the executed individual material removals, which results from the material removal.

Due to the correction of the standardized material removal variables, the accuracy of the method is increased or the device using which the method is carried out is automatically readjusted.

It is particularly advantageous if an algorithm and/or an artificial intelligence is used for the evaluation of the deviation between the resulting unbalance of the rotational component after the material removal and the variable which results from the unbalance minus the unbalance reduction variables of the executed individual material removals, which result from the material removal. This method step can thereby be automated.

Furthermore, it is advantageous if the correction and/or evaluation is carried out on the basis of preceding balancing profile data.

A further preferred exemplary aspect is characterized in that the material removal variables differ from one another in their form and/or in their distance to the axis of rotation of the rotational component and/or in their dimensioning.

It is therefore possible to deal with differently designed rotational component variants.

A further preferred exemplary aspect is characterized in that the determination of the required number of individual material removals and/or the material removal variables is carried out in dependence on the material removal duration and/or the difference between the unbalance and the threshold value variable, thus in particular the intended reduction of the unbalance.

If the requirements are to ensure the least possible unbalance, for example, a higher number of individual material removals having different standardized material removal variables will very probably be necessary. The number and the standardized material removal variables are selected such that the unbalance successively approaches zero after each individual material removal, thus is successively reduced and is approximately eliminated. For this purpose, it is expedient if a smaller standardized material removal variable than before is selected with each further individual material removal. In this way, a particularly high, thus rapid reduction of the unbalance takes place at the beginning of the material removal, while the most accurate possible reduction of the unbalance takes place towards the end with decreasing material removal variable. Such a procedure results in an extremely small unbalance at the cost of the material removal duration. The higher the number of individual material removals and/or the smaller the material removal variables are in relation to the difference between the unbalance and the threshold value variable, the longer the reduction of the unbalance to a variable below the threshold value variable takes. In other words, the greater is the material removal duration. It is therefore very particularly preferred if material removal variables are selected which reduce the material removal duration. This is preferably achieved in that material removal variables are determined or selected which are as large as possible in relation to the difference between the unbalance and the threshold value variable and at the same time are smaller than the unbalance. In other words, due to the determination of the material removal variables, the number of individual material removals are minimized such that the material removal duration is minimized and it is ensured at the same time that the unbalance after the material removal corresponds to a variable below the threshold value variable

It is preferred in principle if the individual material removal variables are graduated in their size in relation to one another. In principle, it is expedient if the individual material removal variables are predetermined. Furthermore, it is preferred if the gradation to the next larger material removal variable is at least 5%, 10%, 15%, 20%, 30%, 40%, or 50%.

The object with respect to the balancing machine is achieved by a balancing machine configured to carry out the method according to the invention. The balancing machine preferably comprises sensors to ascertain the unbalance. Furthermore, it is expedient if the balancing machine has a laser source, which in particular comprises a laser diode or multiple laser diodes, wherein laser radiation or laser beams can be generated by the laser source or the laser diode or the multiple laser diodes. In addition, it is expedient for the balancing machine to comprise a control unit, which is configured to operate the balancing machine. In addition, it is expedient if the control unit is configured to evaluate sensor signals ascertained by the sensors. Furthermore, it is advantageous if the control unit is capable of operating the laser source or the laser diode or the multiple laser diodes. In addition, it is advantageous if the control unit is configured to operate the balancing machine in such a way that the balancing machine carries out the method according to the invention.

A balancing machine is provided in this way which enables a balancing method that is as short as possible with respect to the duration.

The object with respect to the computer program is achieved by a computer program which comprises commands that cause the balancing machine to carry out the method steps of the method according to the invention. Such a computer program can be executed, for example, by the control unit of the balancing machine.

The object with respect to the computer-readable medium is achieved by a computer-readable medium on which the computer program according to the invention is stored. The computer-readable medium is preferably a nonvolatile and/or non-transitory memory. The computer-readable medium or the nonvolatile memory is preferably comprised by the control unit.

The object with respect to the rotational component is achieved in that a rotational component for the method according to the invention is provided. The rotational component is preferably designed in such a way that it comprises a material accumulation and/or material accumulations, in particular made of plastic or brass, which are designed and/or provided to enable the reduction of the unbalance by means of the material removal on the rotational component. In other words, special points are provided on the rotational component, at which the material removal and/or the individual material removals can be performed to reduce the unbalance. In accordance with the statements on the method, the rotational component can include different types of rotational components, such as pump impellers or rotors for pumps. These material accumulations are preferably formed as circles or rings, by which removals in the form of ring segments or circle segments are enabled. In this way, enough material is retained at the required points in order to reduce an unbalance by means of the method according to the invention.

Advantageous developments of the present invention are described in the dependent claims and in the following description of the figures.

### BRIEF DESCRIPTION OF THE DRAWINGS

The invention is explained in more detail hereinafter on the basis of exemplary embodiments with reference to the drawings. In the drawings:

FIG. 1 is a balancing machine; and

FIG. 2 is a flow chart of the method.

### DETAILED DESCRIPTION OF THE PRESENTLY PREFERRED EMBODIMENTS

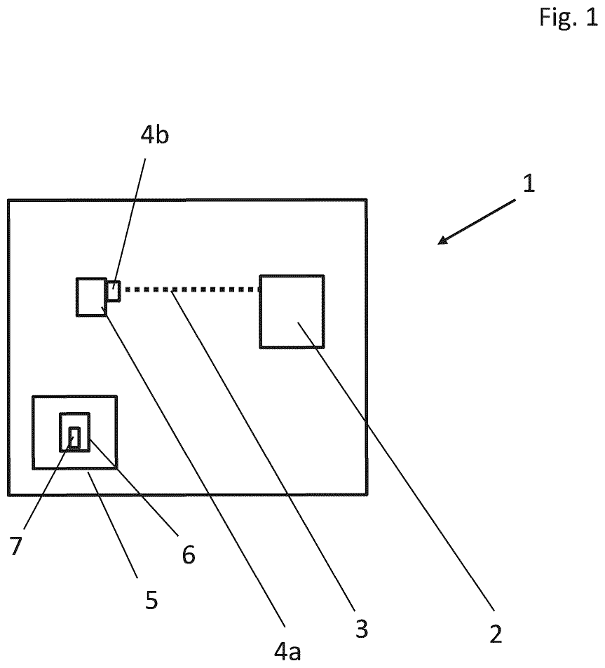

FIG. 1 shows a balancing machine 1 according to one aspect of the invention having a rotational component 2 to be balanced for an electric pump. The electric pump is preferably a vacuum pump, a so-called active purge pump, while the rotational component 2 is a rotor-pump impeller unit. In addition, the balancing machine 1 comprises a laser source 4a, which has a laser diode 4b, using which laser radiation 3 in the form of a laser beam can be directed onto the rotational component 2, by which a material removal is carried out to reduce the unbalance of the rotational component 2, since the rotational component 2 is at least partially formed from plastic. The plastic is matched to the laser beam in such a way that when the laser beam strikes the plastic of the rotational component 2, the material removal takes place. In addition, the balancing machine 1 comprises a control unit 5 having a computer-readable medium 6 according to the invention, which is designed as a nonvolatile memory. The balancing machine is operable by means of the control unit 5. The computer program 7 according to one aspect of the invention is stored on the computer-readable medium 6, wherein the computer program 7 comprises commands which prompt the balancing machine 1 to carry out the method according to the invention.

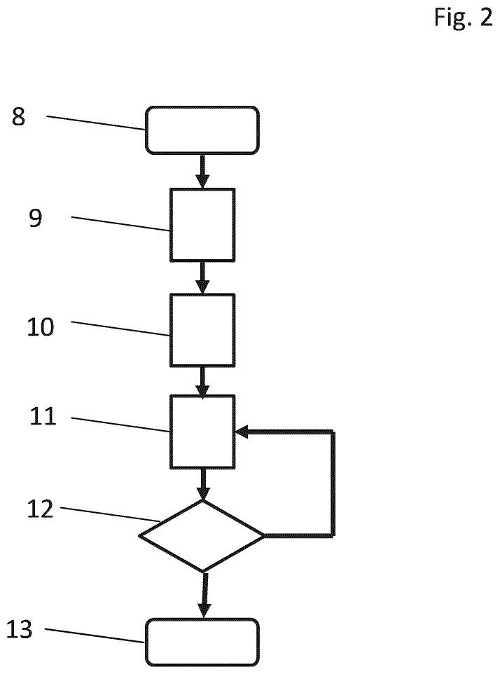

FIG. 2 shows a flow chart of the method according to one aspect of the invention, which can be carried out by the balancing machine from FIG. 1. The initialization 8 of the method takes place first. The first method step 9 thereupon takes place, which comprises determining an unbalance of the rotational component. The second method step 10 thereupon takes place, which comprises determining the number of individual material removals and their material removal variables, in such a way that the resulting unbalance of the rotational component after the material removal corresponds to a variable below the threshold value variable. The third method step 11 takes place next, which comprises reducing the unbalance by a material removal on the rotational component if the unbalance corresponds at least to a threshold value variable. The material removal comprises at least two individual material removals by laser radiation. The fourth method step 12 thereupon takes place, which initiates ending 13 the method if the unbalance resulting after the material removal corresponds to a variable below the threshold value variable. In the case that the unbalance resulting after the material removal still at least corresponds to the threshold value variable, the fourth method step initiates a repetition of the third method step 11, after which the fourth method step 12 takes place again. At the same time, the standardized material removal variable used or the standardized material removal variables used are adapted or corrected by means of an algorithm or an artificial intelligence in such a way that a repetition of the fourth method step 12 is no longer necessary in future.

The different features of the individual exemplary embodiments can also be combined with one another.

The exemplary embodiments of FIGS. 1 to 2 have, in particular, no limiting character and serve to illustrate the concept of the invention.

Thus while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method to reduce an unbalance of a rotational component for an electric pump, comprising:
determining an unbalance of the rotational component;
reducing the unbalance by a material removal on the rotational component if the unbalance at least corresponds to a threshold value variable;
wherein the material removal comprises at least two individual material removals by laser radiation,
assigning one of at least two standardized material removal variables to each of the individual material removals, wherein the at least two standardized material removal variables differ from one another due to unbalance reducing variables assigned thereto; and
determining a number of individual material removals and their material removal variables such that a resulting unbalance of the rotational component after the material removal corresponds to a variable below the threshold value variable.

2. The method as claimed in claim 1, wherein the individual material removals take place at least partially simultaneously or in succession.

3. The method as claimed in claim 1,
wherein after the reduction of the unbalance, the resulting unbalance of the rotational component is ascertained,
wherein the method is repeated if, after the reduction of the unbalance, the resulting unbalance of the rotational component at least corresponds to the threshold value variable, and/or
the method is ended if, after the reduction of the unbalance, the resulting unbalance of the rotational component is below the threshold value variable.

4. The method as claimed in claim 1, further comprising:
correcting the standardized material removal variables if the resulting unbalance of the rotational component after the material removal deviates from a variable which differs from the unbalance minus the unbalance reducing variables of the individual material removals, which results from the material removal.

5. The method as claimed in claim 1, wherein the material removal variables differ from one another in their form, in their distance to an axis of rotation of the rotational component, and/or in their dimensioning.

6. The method as claimed in claim 1, wherein the determination of a required number of individual material removals and/or the material removal variables is carried out in dependence on a material removal duration and/or a difference between the unbalance and the threshold value variable.

7. A balancing machine configured to reduce an unbalance of a rotational component for an electric pump, comprising:
a laser source, which has a laser diode; and
a control unit configured to:
determine an unbalance of a rotational component;
reduce the unbalance by a material removal on the rotational component if the unbalance at least corresponds to a threshold value variable;
wherein the material removal comprises at least two individual material removals by laser radiation from the laser source,
assign one of at least two standardized material removal variables to each of the individual material removals, wherein the at least two standardized material removal variables differ from one another due to unbalance reducing variables assigned thereto; and
determine a number of individual material removals and their material removal variables such that a resulting unbalance of the rotational component after the material removal corresponds to a variable below the threshold value variable.

8. A non-transitory computer-readable medium, on which a computer program comprising commands which cause a control unit to:
determine an unbalance of a rotational component;
reduce the unbalance by a material removal on the rotational component if the unbalance at least corresponds to a threshold value variable;
wherein the material removal comprises at least two individual material removals by laser radiation,
assign one of at least two standardized material removal variables to each of the individual material removals, wherein the at least two standardized material removal variables differ from one another due to unbalance reducing variables assigned thereto; and
determine a number of individual material removals and their material removal variables such that a resulting unbalance of the rotational component after the material removal corresponds to a variable below the threshold value variable.
